(19) United States
(12) Patent Application Publication
(10) Pub. No.: US 2008/0192345 A1
(43) Pub. Date: Aug. 14, 2008

(54) Iodine Polarizing Film, a Method for Producing the Same, and a Polarizing Plate Using the Same

(76) Inventors: Noriaki Mochizuki, Tokyo (JP); Kenichiro Yoshioka, Tokyo (JP); Kouichi Tanaka, Tokyo (JP); Yoshiaki Matsushita, Tokyo (JP)

Correspondence Address: Nields & Lemack, 176 E. Main Street, Suite #5, Westboro, MA, 01581, US

(21) Appl. No.: 11/885,685

(22) PCT Filed: Mar. 9, 2006
(86) PCT No.: PCT/JP06/04603

§ 371 Date: Oct. 19, 2007

(30) Foreign Application Priority Data
Mar. 10, 2005 (JP) 2005-066915
May 25, 2005 (JP) 2005-151797

(51) Int. Cl. G02B 5/30; B29D 11/00; G02F 1/1335

(52) U.S. Cl. 359/485; 428/1.31; 349/96; 264/1.34

(57) ABSTRACT

The present invention relates to a polarizing film obtained by stretching a polyvinyl alcohol resin film containing iodine, an iodide a cross-linking agent and/or waterproofing agent and then treating the film with a solution containing 0.0001 to 5.0 wt % of inorganic acid except for boric acid or a salt thereof and/or organic acid and having a pH of preferably 2≦pH≦5, more preferably 2.2≦pH≦5. Said polarizing film is excellent in wet heat durability and shows less decrease in polarization characteristics in wet heat test and said polarizing film obtained in a further preferable embodiment is also excellent in dry heat durability.

### TECHNICAL FIELD

The present invention relates to an iodine polarizing film, a method for producing it, and an iodine polarizing plate using the iodine polarizing film.

### BACKGROUND OF THE INVENTION

A polarizing plate is typically produced by adsorption of iodine or dichroic dye being dichroic coloring matter to a polyvinyl alcohol resin film and orientation to prepare a polarizing film, either one surface or the both surfaces of which is (are) then laminated with a protective film composed of triacetyl cellulose and the like through an adhesive layer to provide a polarizing plate, and the polarizing plate is used for liquid crystal display devices. A polarizing plate composed of a polarizing film using iodine as dichroic coloring matter is called an iodine polarizing plate, on the other hand a polarizing plate composed of a polarizing film using dichroic dye as dichroic coloring matter is called a dye type polarizing plate. An iodine polarizing plate exhibits high transmittance and high polarization degree, i.e., high contrast, compared with a dye type polarizing plate, and hence is widely used for common liquid crystal monitors, liquid crystal TV sets, cellular phones, PDAs and the like. However, an iodine polarizing plate is superior to a dye type polarizing plate in optical characteristics but inferior to a dye type polarizing plate in optical durability, and, for example, leaving an iodine polarizing plate under the conditions of high temperature and high humidity has posed such problems that the transmittance increases, the polarization degree decreases, and so on, due to decoloring. In addition, for dry heat durability, when it is left under high temperature, the decrease in the polarizing degree occurs. A polarizing plate having high transmittance and polarizing degree, high contrast, and excellent heat resistance and wet heat resistance is required, and as an invention for this requirement, Patent Literature 1 and Patent Literature 2 describes a method for improvement by the protective films and Patent Literature 3 and Patent Literature 4 describes improvement of wet heat durability by property modification of adhesives used for adhesion of a protective film composed of triacetyl cellulose. In addition, there are some cases where the durability of an iodine polarizing plate is improved, not by a protective film and an adhesive but by treatment of a polyvinyl alcohol resin film. As one of them, Patent Literatures 5, 6, 7 and 8 describe improvement of durability by acid treatment and pH control. For example, Patent Literature 5 discloses a polarizing film whose durability is improved by using a polyvinyl alcohol resin stretched film which is prepared by immersion of a polyvinyl alcohol resin film produced by film-forming a polyvinyl alcohol resin film containing a boron compound in an acid aqueous solution and by stretching it. In addition, Patent Literature 6 discloses a method for producing a polarizing film excellent in wet heat resistance which is subjected to oxidation treatment of a film composed of a polyvinyl alcohol resin in an oxidation bath containing an oxidant such as a hydrogen peroxide containing an iodide of alkali metal. Patent Literature 7 discloses a method for producing an iodine polarizing film having wet heat resistance improved by treatment of a polyvinyl alcohol film subjected to uniaxially stretching and adsorption orientation treatment of iodine in a boric acid aqueous solution having a pH of no higher than 4.5. Patent Literature 8 discloses a patent of a polarizer (polarizing film) where the liquid dissolving it in water has a pH of 1.0 to 5.0.
Patent Literature 1: JP 1996-5836 A
Patent Literature 2: JP 2001-272534 A
Patent Literature 3: JP 2004-12578 A
Patent Literature 4: JP 1997-269413 A
Patent Literature 5: JP 1994-254958 A
Patent Literature 6: JP 1995-104126 A
Patent Literature 7: JP 2001-83329 A
Patent Literature 8: JP 2005-62458 A

### DISCLOSURE OF THE INVENTION

### PROBLEMS TO BE SOLVED BY THE INVENTION

The method described in Patent Literature 5 where a polyvinyl alcohol resin film produced by film-forming a polyvinyl alcohol resin film containing a boron compound is immersed in an acid aqueous solution and stretched has posed a problem that improvement effect of durability of an obtained polarizing film cannot be obtained sufficiently due to elution of acidic constituent from a polyvinyl alcohol resin film into an aqueous solution for immersion (so called dye bath) containing boric acid, iodine and a potassium iodide during stretching. In addition, in Patent Literature 6, there is a problem that improvement effect of wet heat resistance of an obtained polarizing film cannot be obtained sufficiently due to elution of oxidant from a polyvinyl alcohol resin film into a stretching bath during stretching because of treatment in an oxidation bath with the pH adjusted before stretching. Patent Literature 7 describes that an aqueous solution containing boric acid is subjected to treatment while maintaining the pH at no higher than pH≦4.5, but when acid is subjected to the treatment together with boric acid, the effect of the treatment to the film is not constant due to low treatment efficiency of the polyvinyl alcohol resin film and the acidic substance. For example, in an Example of Patent Literature 7, the change of polarizing degree is 1.3 in the case of treating with treatment liquid containing boric acid having a pH=3.4, and the change of polarizing degree is 2.0 in the case of the pH=2.1. This shows that stable properties cannot be obtained by this method although the pH is controlled, and that desired durability cannot be stably provided although the pH is controlled. Furthermore, the literature describes that an acidic substance vaporizes if the treatment temperature (treatment liquid temperature) during the process is high. Patent Literature 8 discloses a patent of a polarizer characterized by that it is composed of a film produced by stretching a polyvinyl alcohol film and by that the liquid dissolving it in water has a pH of 1.0 to 5.0. However, although wet heat durability of a polarizing plate obtained by this method is improved, the display of a liquid crystal display device may gradually darken depending on the light source and use environment of the liquid crystal display device because reduction of transmittance is significant in a heat test, for example, under an atmosphere of high temperature such as 90° C. These problems have required an iodine polarizing plate having improved wet heat durability and excellent dry heat durability by applying treatment with acidic substances with a solution not containing boric acid to a polyvinyl alcohol resin film containing iodine so as to allow efficient treatment as well as treatment at not only high but also low treatment temperatures for stable acid concentration.

### MEANS OF SOLVING THE PROBLEMS

The inventors of the present invention have made earnest studies to solve the above problems, found that the polarizing film has improved wet heat durability and less transmittance change which is obtained by treatment of a polyvinyl alcohol resin film containing iodine, an iodide, a cross-linking agent and/or a waterproofing agent with a solution containing 0.0001 to 5.0% by weight (hereinafter, referred to as wt % for simplicity, and shown by % unless otherwise specifically noted) of inorganic acid except for boric acid or a salt thereof and/or organic acid (hereinafter optionally, also referred to as solution for acid treatment) after stretching treatment, further that stable treatment can be applied without vaporization of acidic substance because treatment of the acidic substance can be carried out at not only high but also low treatment temperatures, and furthermore that dry heat durability is also improved when the pH of the solution for acid treatment is 2 to 5, more preferably 2.2 to 5, or optionally 2.4≦pH<6.0, and newly found that a polarizing plate can be obtained which has small variation of optical characteristics, high wet heat durability and excellent dry heat durability by applying treatment with a solution having 2.4≦pH<6.0 containing an acidic substance together with a halogenide without applying boric acid, rather than using an acidic substance together with boric acid for pH≦4.5, and by applying drying treatment after treatment with acidic substances, and completed the present invention.

That is, the present invention relates to
(1) A polarizing film obtained by treatment of a polyvinyl alcohol resin film containing iodine, an iodide, a cross-linking agent and/or a waterproofing agent with a solution containing 0.0001 to 5.0 wt % of an inorganic acid or a salt thereof and/or organic acid except for boric acid (hereinafter, referred to as solution for acid treatment) after stretching,
(2) The polarizing film according to the above (1), wherein the pH of the solution for acid treatment is 2≦pH≦5,
(3) The polarizing film according to the above (1), obtained by treatment of a polyvinyl alcohol resin film containing iodine, an iodide, a cross-linking agent and/or a waterproofing agent with a solution for acid treatment having a pH of 2.4≦pH<6.0 after stretching treatment,
(4) The polarizing film according to the above (1), characterized by containing a halogenide in the solution containing inorganic acid or a salt thereof and/or organic acid except for boric acid,
(5) The polarizing film according to the above (1), wherein the inorganic acid except for boric acid or the salt thereof is any one or no less than two of aluminium sulfate, an aluminium chloride, aluminium nitrate or sulfuric acid,
(6) The polarizing film according to the above (1) and (2), wherein the inorganic acid or the salt thereof except for boric acid is aluminium sulfate,
(7) The polarizing film according to any one of the above (1) to (6), wherein the organic acid is no less than one kind of carboxylic acid and/or α-hydroxy acid, and which is obtained by treatment with a solution containing said organic acid,
(8) The polarizing film according to the above (7) wherein the organic acid is any one or no less than 1 of citric acid, oxalic acid, malic acid, tartaric acid or acetic acid, and which is obtained by treatment with a solution containing said organic acid,
(9) The polarizing film according to any one of the above s (1) to (8), wherein the above polyvinyl alcohol resin film after stretching is one stretched at a stretching ratio of 3 to 8 times compared before stretching,
(10) The polarizing film according to the above (1) or (9), characterized by that the cross-linking agent and/or the waterproofing agent to be used during stretching treatment is boric acid,
(11) A polarizing plate provided with a protective layer on either or both of the surfaces of the polarizing film according to any of the above s (1) to (9),
(12) A liquid crystal display device characterized by having the polarizing plate according to claim 11,
(13) A method for producing a polarizing film characterized by treatment of a polyvinyl alcohol resin film containing iodine, an iodide, a cross-linking agent and/or a waterproofing agent with a solution for acid treatment having 2.4≦pH<6.0 after stretching treatment,
(14) A method for producing a polarizing plate characterized by providing a protective layer on either or both of the surfaces of the polarizing film obtained by treatment of a polyvinyl alcohol resin film containing iodine, an iodide, a cross-linking agent and/or a waterproofing agent with a solution for acid treatment having 2.4≦pH<6.0 after stretching treatment,
(15) A method for producing a polarizing film characterized by treatment a polyvinyl alcohol resin film containing iodine, an iodide, and a cross-linking agent with a solution for acid treatment having 2.2≦pH≦5 after stretching treatment,
(16) A method for producing a polarizing film characterized by treatment a polyvinyl alcohol resin film containing iodine, an iodide, and a cross-linking agent and/or waterproofing agent with a solution containing 0.0001 to 5.0 wt % of inorganic acid except for boric acid or a salt thereof and/or organic acid (hereinafter, referred to as solution for acid treatment) after stretching,
(17) A method for producing the polarizing film according to the above (15), wherein the solution for acid treatment is an aqueous solution containing at least one kind of acidic substance selected from the group consisting of sulfuric acid, hydrochloric acid, nitric acid, aluminium sulfate, an aluminium chloride, aluminium nitrate, formic acid, citric acid, chloroacetic acid, acetic acid, oxalic acid, malic acid and tartaric acid,
(18) A method for producing the polarizing film according to the above (16) or (17), wherein the pH of the solution for acid treatment is 2 to 5.

### EFFECT OF THE INVENTION

The obtained polarizing film doesn't carry any acidic substance into a dye bath due to the treatment with an acidic substance after stretching nor poses problems by precipitation of boric acid due to not using boric acid after stretching, so the polarizing film can be stably produced industrially. Further, an excellent polarizing film or polarizing plate can be obtained where the transmittance change and the decrease of polarizing degree are low under wet heat environment, for example, in the conditions of a temperature of 65° C. and a relative humidity of 93%, and where the transmittance change is low even under dry heat environment, for example, at 90° C. if they are produced under preferable conditions. By using such a polarizing film or a polarizing plate of the present invention, liquid crystal displays can ensure display stability for a long period of time.

### BEST MODE FOR CARRYING OUT THE INVENTION

Hereinafter, the present invention will be explained specifically.

The method for producing a polyvinyl alcohol resin composing a polarizing film is not particularly limited and a known method is used for producing. As the method, for example, saponification of a polyvinyl acetate resin can be used to obtain. As the polyvinyl acetate resin, vinyl acetate and a copolymer of other monomer copolymerizable therewith other than polyvinyl acetate being a homopolymer of vinyl acetate are exemplified. Other monomers which copolymeriz with vinyl acetate include, for example, unsaturated carboxylic acids, olefins, vinyl ethers, unsaturated sulfonic acids and the like. The saponification degree of polyvinyl alcohol resin is typically approximately 85 to 100 mol %, preferably not less than 95 mol %. This polyvinyl alcohol resin may be further modified, and for example, polyvinyl formal and polyvinyl acetal modified with aldehydes can be used. And the degree of polymerization of polyvinyl alcohol resin is typically approximately 1,000 to 10,000, preferably approximately 1,500 to 5,000.

A film prepared by film-forming such a polyvinyl alcohol resin is used as a raw fabric film. The method for film-forming a polyvinyl alcohol resin is not particularly limited and a known method can be used for film-forming. In this case, the polyvinyl alcohol resin film may contain glycerin, ethylene glycol, propylene glycol, low molecular-weight polyethylene glycol and the like as a plasticizer. The amount of a plasticizer is 5 to 20 wt %, preferably 8 to 15 wt %. The thickness of a raw fabric film composed of a polyvinyl alcohol resin is not particularly limited but preferably 5 to 150 μm, particularly preferably 10 to 100 μm.

The above polyvinyl alcohol resin film (hereinafter, also referred to as PVA film) is firstly subjected to swelling treatment (also referred to as swelling process). The swelling treatment is carried out by immersion in a solution of 20 to 50° C. for 30 seconds to 10 minutes. The solution in this case is preferably water, but may be a water soluble organic solvent such as glycerin, ethanol, ethylene glycol, propylene glycol or low molecular-weight polyethylene glycol, or a mixture solution of water and a water-soluble organic solvent. In the case that the time of producing a polarizing film is shortened, the swelling process may be omitted because swelling is carried out in treatment with iodine and an iodide.

After the swelling process, the polyvinyl alcohol resin film is treated with a solution containing iodine and an iodide (hereinafter, also referred to as dyeing process). As the treatment method, immersion in said solution is preferable, and the treatment may be performed by applying or coating the solution on the polyvinyl alcohol resin film. The solvent of the solution is, for example, preferably water, but not limited thereto. As the iodide, for example, an alkali metal iodide compound such as potassium iodide, ammonium iodide, cobalt iodide, or zinc iodide and the like can be used, and it is not limited but typically preferably an alkali metal iodide compound, and more preferably potassium iodide. The concentration of iodine is preferably 0.0001 to 0.5 wt %, more preferably 0.001 to 0.4 wt %. The concentration of iodide is preferably 0.0001 to 8 wt %. The treatment temperature in this process is preferably 5 to 50° C., more preferably 5 to 40° C., and particularly preferably 10 to 30° C. The processing time can be modestly adjusted because it depends on the concentration at which the iodine and iodide are adsorbed, but is preferably adjusted from 30 seconds to 6 minutes, and more preferably from 1 to 5 minutes. After this treatment, washing may be carried out before the next process. As a solvent for washing, typically water is used. Washing can control transfer of the iodine and iodide into a liquid for next treatment.

In the iodine and iodide treatment, a cross-linking agent and/or a waterproofing agent may be added to the solution. Typically, a cross-linking agent is used. As the cross-linking agent, usually boric acid is preferable but not particularly limited. The concentration of a cross-linking agent, for example boric acid, to be added is preferably 0.1 to 5.0 wt %, more preferably 2 to 4 wt %. As the waterproofing agent, the agent mentioned later can be used. The treatment temperature in this process is preferably 5 to 50° C., more preferably 5 to 40° C., and particularly preferably 10 to 30° C. The processing time can be modestly adjusted because it depends on the concentration at which the iodine and iodide are adsorbed, but is preferably adjusted from 30 seconds to 6 minutes, more preferably 1 to 5 minutes. After this treatment, washing may be carried out before the next process. As a solvent for washing, typically water is used. Washing can control transfer of the iodine, iodide and boric acid into a liquid for next treatment.

When the present invention mentions a polyvinyl alcohol resin film containing iodine, an iodide, a cross-linking agent and/or a waterproofing agent, iodine, an iodide, a cross-linking agent and/or a waterproofing agent are not necessarily contained directly in a PVA film, including the case that iodine, an iodide, a cross-linking agent and/or a waterproofing agent are contained in reacted form in said PVA film through the above dyeing treatment and treatments of cross-linking agent and/or waterproofing agent. For a PVA film containing iodine, an iodide, a cross-linking agent and/or a waterproofing agent, iodine, an iodide and/or a cross-linking agent (preferably boron) are preferably contained.

Typically after the above dyeing process, the cross-linking treatment agent is carried out (also referred to as process for cross-linking agent treatment). The cross-linking agent treatment can be carried out by treating a polyvinyl alcohol resin film with a solution containing a cross-linking agent. As described above, the dyeing process can be carried out under the presence of a cross-linking agent, but typically the cross-linking agent treatment is carried out preferably after the dyeing process. In this case, the cross-linking agent treatment is carried out by treating a polyvinyl alcohol resin film obtained in said dyeing process (hereinafter, also referred to as a dyed PVA film) with a solution containing a cross-linking agent. As the treatment method with a solution containing said cross-linking agent, typically immersion of a dyed PVA film in said solution is preferable, but applying or coating said solution on a polyvinyl alcohol resin film may be employed. Said immersion can be carried out before the stretching treatment mentioned later, and together with said stretching treatment. In the case that said stretching method is a dry stretching method, the cross-linking treatment is carried out preferably before the stretching, and in the case of a wet stretching method, it is carried out preferably together with said stretching treatment. As the cross-linking agent, for example, a boron compound such as boric acid or a salt thereof (e.g. an alkali metal salt such as borax, ammonium borate or the like), polyvalent aldehyde such as glyoxal or glutaraldehyde, a polyvalent isocyanate compound such as a biuret-type, an isocyanurate type or a block type, a titanium compound such as titanium oxysulfate, ethylene glycol glycidyl ether, polyamide epichlorohydrin and the like can be used. Typically, a boron compound is preferable and boric acid is more preferable. And a waterproofing agent can be present together in the solution containing a cross-linking agent. The waterproofing agent includes succinate peroxide, ammonium persulfate, calcium perchlorate, benzoin ethyl ether, ethylene glycol diglycidyl ether, glycerin diglycidyl ether, ammonium chloride or magnesium chloride, zinc chloride and the like, preferably ammonium chloride, magnesium chloride, zinc chloride or the like. As the solvent in the cross-linking agent treatment, for example, water, an alcohol solvent, a glycol solvent, glycerin or a mixed solvent thereof can be used, and typically water is preferable. The concentration of cross-linking agent in the solution containing a cross-linking agent differs depending on the kind of cross-linking agent and it depends, but typically the treatment is preferably carried out at a concentration of approximately 0.1 to 10 wt/vol % to the solvent, and when taking boric acid as an example, preferably a concentration of 0.1 to 6.0 wt/vol % to the solvent, more preferably 2 to 4 wt/vol %. The treatment temperature is preferably 5 to 60° C., more preferably 5 to 40° C. The processing time is preferably 30 seconds to 6 minutes, more preferably 1 to 5 minutes.

Next, the above dyed PVA film or a PVA film subjected to dye treatment and cross-linking agent treatment is stretched (preferably uniaxially stretched) so as to provide polarization characteristics (hereinafter, also referred as to a uniaxially stretching process). As the stretching method, any of a wet stretching method and a dry stretching method can be employed. In the case of a dry stretching method, typically a PVA film subjected to cross-linking agent treatment is employed. In the case of a wet stretching method, a PVA film subjected to cross-linking agent treatment may be employed but preferably the above dyed PVA film which is not subjected to cross-linking agent treatment is employed to carry out the cross-linking agent treatment during stretching.

The dry stretching method is carried out by heat stretching the above film typically in a gas medium. As said gas medium, air, inert gas or the like can be used, and typically air is used for economic reasons and the like. In the case of an air medium, preferably, the temperature of said medium is adjusted between ordinary temperature to approximately 180° C. and then a PVA film subjected to cross-linking agent treatment is stretched. In the case of inert gas or the like, the stretching can be carried out in the same manner as in the case of air, or optionally at a higher temperature. Further, said stretching treatment is preferably carried out in an atmosphere of a relative humidity of 20 to 95%. As a method for the heat stretching of a film, there are possible methods such as roll stretching method, a heating roll stretching method, a pressure stretching method or an infrared heat stretching method and the like, but the stretching method is not limited. The stretching treatment may be carried out once (one stage) and a multistage treatment of twice (two stages) or more may be applied. The stretching ratio in such a case is preferably 3 to 8 times, more preferably 5 to 7 times.

In the wet stretching method, typically the above film is immersed in an aqueous medium such as water, a water soluble organic solvent or a mixed solution of water and said organic solvent and stretched under heating. The stretching is preferably carried out with the above film being immersed in a solution containing a cross-linking agent and/or waterproofing agent. The stretching ratio is preferably 3 to 8 times, and more preferably 5 to 7 times. The stretching is preferably carried out in said aqueous medium heated at 40 to 60° C., and more preferably 45 to 55° C. The cross-linking agent can include the above ones, for example, a boron compound such as boric acid, borax or ammonium borate, a polyvalent aldehyde such as glyoxal or glutaraldehyde, a polyvalent isocyanate compound such as a biuret type, an isocyanurate type or a block type, a titanium compound such as titaniumoxy sulfate, ethylene glycolglycidylether, polyamide epichlorohydrin or the like. The cross-linking agent is preferably a boron compound, and more preferably boric acid. The waterproofing agent can include the above ones, for example, succinate peroxide, ammonium persulfate, calcium perchlorate, benzoinethyl ether, ethylene glycol diglycidyl ether, glycerin diglycidyl ether, ammonium chloride, magnesium chloride, zinc chloride and the like. The concentration of cross-linking agent and/or waterproofing agent is, for example, preferably 0.5 to 8 wt %, and more preferably 2.0 to 4.0 wt %. The stretching time can be 30 seconds to 20 minutes, preferably 2 to 5 minutes. The stretching treatment may be carried out once (one stage), or a multistage treatment of twice (two stages) or more may be applied.

The present invention is characterized by that the PVA film uniaxially stretched above (hereinafter, also referred to as uniaxially stretched PVA film for simplicity) is treated with a solution containing 0.0001 to 5.0% by weight of inorganic acid except for boric acid or a salt thereof and/or organic acid (hereinafter, also referred to as acidic substance for simplicity) (hereinafter, also referred to as solution for acid treatment). This treatment can improve wet heat durability of the polarizing film and further can improve dry heat durability in a preferred embodiment. Hereinafter optionally, this treatment is also referred to as “treatment with an acidic substance” for simplicity. In the treatment with an acidic substance, typically, the above stretched PVA film is preferably immersed in a solution containing an acidic substance (preferably, an aqueous solution, a water soluble organic solvent solution or a mixed solution of said organic solvent and water).

After the above stretching treatment is carried out, washing the film surface may be carried out (hereinafter, also referred to as washing process) before the treatment with an acidic substance because precipitation of a cross-linking agent may be produced or foreign matter may be attached on the film surfaces. Washing with a solution containing boric acid may be carried out in this washing process, but typically if washing is carried out, preferable is washing with a solution not containing boric acid, preferably water, because optionally washing with a solution containing boric acid may produce foreign matter on the surfaces in the next process or after drying. In this connection, washing with a solution containing boric acid can be carried out in the case including such treatment process that after said washing, acid treatment and then drying are carried out, in order not to produce foreign matter on film surfaces after washing with a solution containing boric acid. The washing time can be 1 second to 5 minutes. The number of washing carried out is not particularly limited and may be once or, if required, a plural number washing of twice or more.

After the stretching treatment, the stretched PVA film is preferably treated with a solution containing a halogenide, together with the treatment with an acidic substance or separately. This treatment aims at adjustment of hue and improvement of polarization characteristics (hereinafter, also referred to as halogenide treatment). The treatment method includes a method where the stretched PVA film is immersed in said solution, a method where said solution is applied or coated on said PVA film, and the like, and a method of immersion is more preferable. And this halogenide treatment is preferably carried out together with the treatment with an acidic substance. In this case, said PVA film can be treated with a solution containing a halogenide together with an acidic substance by the above method. The halogenide is preferably, for example, an alkali metal iodide compound such as potassium iodide and sodium iodide, an iodide such as ammonium iodide, cobalt iodide or zinc iodide, alkali metal chloride compound such as potassium chloride and sodium chloride or chloride such as zinc chloride, and it is further preferably water soluble. An iodide is more preferable than a chloride, and among iodides an alkali metal iodide compound is preferable and a potassium iodide is more preferable. The concentration of halogenide is preferably 0.5 to 15 wt %, and more preferably 3 to 8 wt %. The treatment temperature is preferably, for example, 5 to not higher than 50° C., and more preferably 20 to 40° C. The processing time is advantageously, for example, 1 second to 5 minutes, and preferably 5 to 30 seconds in view of stability of the characteristics in the plane of polarizing film. In the case of not aiming at adjustment of hue, this process for the treatment with a solution containing a halogenide can be omitted.

After treatment with an acidic substance, and if required, halogenide treatment are carried out, drying a film is carried out (hereinafter, also referred as to drying process). In drying, natural drying is advisable, but in order to enhance drying efficiency further, water removal of the surfaces may be carried out by means of compression by rolls, or by means of air knife, water absorbing roll or the like, and/or blow drying may be carried out. As for treatment temperature, the treatment is advantageously carried out at 20 to 90° C., preferably 40 to 80° C. The processing time is preferably 30 seconds to 20 minutes, and more preferably 2 to 10 minutes.

The solvents for treatment solution in the treatment processes so far include, for example, a solvent such as water, an alcohol solvent or a glycol solvent, but not limited thereto. Besides, a mixed solvent of water and a water soluble organic solvent such as a mixed solution of water and alcohols and a mixed solvent of dimethylsulfoxide and water may be used. The most preferable is water.

The treatment with an acidic substance in the present invention may be carried out in any of the processes as long as after the polyvinyl alcohol film containing iodine, an iodide, a cross-linking agent and/or a waterproofing agent is stretched (preferably uniaxially stretched). The treatment with an acidic substance can be carried out in any time of the processes, for example, in the washing process after said stretching or/and the halogenide treatment process, otherwise separately, continuously after stretching said film or after washing process which is carried out if necessary. Typically, after completion of the stretching (preferably, uniaxially stretching) for providing polarization characteristics and if necessary then washing, the treatment with an acidic substance (also referred to as acid treatment) is preferably carried out. In addition, it may be carried out in the plural processes, if necessary. More preferable is a method of carrying out halogenide treatment together with treatment with an acidic substance by immersing said stretched PVA film in a solution containing an acidic substance and a halogenide. The treatment with an acidic substance may be carried out with a treatment solution containing a cross-linking agent, except for boric acid, and/or a waterproofing agent, if necessary, together with said acidic substance. The concentration of acidic substance in a treatment solution to be used for treatment with an acidic substance is typically within the rage of approximately 0.0001 to 5.0 wt %, preferably 0.0005 to 2 wt %, more preferably 0.001 to 1 wt %, and optionally more preferably 0.01 to 2.0 wt %. And the pH of said treatment solution is preferably adjusted at 1.0≦pH<6.0. More preferable pH is in the range of no less than 2 and under 6.0, and further preferable is approximately 2.1 to 5. The temperature and time of the acid treatment is not particularly limited as long as effect of the present invention is achieved, typically the treatment temperature being 5 to less than 60° C., preferably approximately 10 to 40° C., and the processing time being 2 to 300 seconds, preferably 3 to 60 seconds, more preferably approximately 5 to 40 seconds.

Optionally, in the washing process, acid treatment can be carried out with a solution containing an acidic substance at the same time with washing. The treatment temperature is preferably 5 to less than 60° C., and more preferably 10 to 40° C. The processing time is preferably 2 to 300 seconds, and more preferably 2 to 60 seconds.

The halogenide treatment can be carried out after stretching treatment or washing treatment, alone or together with acid treatment in the acid treatment process as described above. The halogenide treatment is preferably carried out typically together with acid treatment in the acid treatment process as described above in the course of treatment of said stretched film by applying a solution containing a halogenide on said PVA film (hereinafter, stretched film for simplicity) after said stretching. As the method for treatment of said film with a solution containing said halogenide, any method can be used as long as said solution is applied on the surfaces of said stretched film. Typically, said stretched film is preferably immersed in said solution. In the case of carrying out the halogenide treatment together with the above acid treatment process, said film can be treated with a solution containing said halogenide together with the above acidic substance. Said stretched film is preferably immersed in a solution preferably containing the both. The concentration of halogenide in the solution containing a halogenide to be used for halogenide treatment is preferably in the range of 0.5 to 15 wt %. In the case of carrying out halogenide treatment together with acid treatment, a solution containing halogenide in the above concentration range and acidic substance in the range of 0.0001 to 5.0 wt % can be used. And the treatment temperature is preferably, for example, 5 to less than 60° C., and more preferably 20 to 40° C. The processing time can be 2 seconds to 5 minutes, preferably 5 seconds to 1 minute.

As the acidic substance, both of an inorganic acid and an organic acid can be used, and further a salt thereof can be used whose aqueous solution shows acidity, and preferably also shows a value under pH 6, preferably under pH 5 and no less than pH 1. The inorganic acid preferably includes acid such as sulfuric acid, hydrochloric acid or nitric acid. Among them sulfuric acid is more preferable. Typically a salt of inorganic acid is used as the salt, and a salt of the above preferable inorganic acid, in particular, an aluminum salt is preferable. Such a salt can include aluminium sulfate, an aluminium chloride, aluminium nitrate or the like. Aluminium sulfate is one of particularly preferable salts. A zinc chloride to be used as a waterproofing agent or the like is not included in the above acidic substances in the present invention because its aqueous solution is not in the above pH range. The organic acid typically can include carboxylic acids, preferably C1 to C4 saturated fatty acid which may have hydroxy substitution or halogeno substitution, and water soluble organic acid having a skeletal structure of α-hydroxy acid is one of preferable organic acids. The specific examples include, for example, formic acid, citric acid, chloroacetic acid, acetic acid, oxalic acid, malic acid, tartaric acid or the like, preferably citric acid or acetic acid, and most preferably acetic acid. Each kind of the acidic substances may be used and not less than two kinds of them may be mixed to be used. Among these acidic substances, aluminium sulfate is one of particularly preferable acidic substances because it can provide high efficiency to enhance wet heat durability. As the organic acid, citric acid, acetic acid, oxalic acid and the like are commonly used as a food additive and preferable acidic substances from environmental and safety points of view.

Preferable acidic substances include at least one kind of acidic substances selected from the group consisting of sulfuric acid, an aluminum salt of inorganic acid (preferably an aluminum salt of inorganic acid selected from the group consisting of sulfuric acid, hydrochloric acid or nitric acid), citric acid and acetic acid, particularly preferably aluminium sulfate or/and acetic acid.

A solution containing an acidic substance may contain a cross-linking agent (desirably, a cross-linking agent except for boric acid) and/or a waterproofing agent all together. As a cross-linking agent except for boric acid, for example, polyvalent aldehyde such as glyoxal or glutaraldehyde, a polyvalent isocyanate compound such as a biuret type, an isocyanurate type or a block type, a titanium compound such as titaniumoxy sulfate and the like can be used, and in addition, ethylene glycol glycidyl ether, polyamide epichlorohydrin or the like can be used. The waterproofing agent includes a succinate peroxide, ammonium persulfate, calcium perchlorate, benzoinethyl ether, ethylene glycol diglycidyl ether, glycerin diglycidyl ether, an ammonium chloride, a magnesium chloride, a zinc chloride, and the like.

When the treatment with a solution containing an acidic substance is carried out, the pH of the solution is also an important index. As the pH is lower, the polarizing film has higher wet heat durability. However, a too low pH may cause decomposition of polyvinyl alcohol resin and polyenization. That may change transmittance by no less than 1% in dry heat test, for example, heat resistance test of 90° C. This shows that adjusting the pH of a solution containing an acidic substance (solution for acid treatment) at 1.0≦pH<6.0 is appropriate to obtain higher wet heat durability, and the range is more preferably in the range of 2≦pH≦5. In order to also obtain higher dry heat durability, the pH is not less than 2, and more preferably the range of not less than 2.2 and under 6.0 is preferable, further preferably approximately 2.2 to 5. Furthermore, optionally the pH is preferably 2.4≦pH<6.0, more preferably 2.4≦pH≦5.0, and further preferably in the range of 2.4≦pH≦4.0.

The preferable polarizing film of the present invention has both high wet heat durability and high dry heat durability and also less decrease in transmittance. For such superior polarizing film of the present invention, the pH of an aqueous solution dissolving said polarizing film is in the range of 5.0<pH<6.0, which is one of indexes of the superior polarizing film of the present invention. And it is more preferable that the pH of said aqueous solution is in the range of 5.1 to 5.6. Further, it is often the case that the polarizing film is more preferable when a polarizing film with the pH of said aqueous solution being 5.2<pH<5.6 also, and for the most preferable polarizing film, the pH of said solution is 5.2<pH<5.4. The pH of an aqueous solution dissolving a polarizing film of the present invention can be measured as follows.

That is, the polarizing film of the present invention obtained after drying process is cut out 0.0380 g, which is put in a screw-cap glass bottle (screw-cap glass bottle SV-30 manufactured by TAKARA. Co. Ltd) with 10 cc of distilled water in. Then the cap is sealed and the glass bottle is immersed in a water bath in boiling condition for 2 hours to obtain an aqueous solution dissolving a polarizing film. Said aqueous solution is cooled to 25° C. and the pH of said aqueous solution was measured using a pH Controller PP-01 manufactured by ASONE Corporation, which pH obtained is defined as the pH of an aqueous solution dissolving the polarizing film of the present invention. Said aqueous solution just has to dissolve a polarizing film in it and the whole polarizing film of the present invention used as the sample is not necessarily dissolved, and the polarizing film as the sample itself may be in the state of half-dissolving, sufficiently swelling or the like. However, preferably insoluble part of the polarizing film of the sample is desirably less than 20 wt %.

As the polyvinyl alcohol resin film thus obtained by treatment with a solution containing 0.0001 to 5.0 wt % of acidic substance is treated with a solution having a higher concentration (a lower pH) of acidic substance, the pH of the obtained solution dissolving the polarizing film shows a lower pH value. This shows that the concentration of acidic substance has a correlation with the pH of the polarizing film, and that the pH of the solution dissolving the polarizing film, in other words, the degree of treatment of the obtained polarizing film can be controlled by controlling the acidic substance of the treatment solution. For producing the polarizing film, the concentration of acidic substance is an important factor.

A preferable method for producing the polarizing film of the present invention is a method characterized by that, for example, in order to provide polarization characteristics, a PVA film dyed with iodine and iodide is stretched (preferably uniaxially stretched) by 3 to 8 times, preferably approximately 4 to 7 times preferably in an aqueous solution containing a cross-linking agent (preferably boron), otherwise a PVA film dyed with iodine and iodide and subjected to cross-linking agent treatment (preferably boron treatment) is stretched (preferably uniaxially stretched) by 3 to 8 times, preferably approximately 4 to 7 times by dry stretching method, and then the obtained stretched film is subjected to acid treatment and halogenide treatment with the above solution for acid treatment, preferably a solution containing the above acidic substance and a halogenide, and the film subjected to said treatment can be dried to obtain a dried polarizing film of the present invention.

By the processes mentioned above, the iodine polarizing film of the present invention produced by stretching a polyvinyl alcohol resin film can be obtained.

The resulting polarizing film becomes a polarizing plate by providing a transparent protective layer on at least one or both of the surfaces. The transparent protective layer can be provided as a coating layer of polymer or a laminate layer of the film. The transparent polymer or film forming the transparent protective layer is advantageously a transparent polymer or film having high mechanical strength and good heat stability. Further, preferable is one having excellent water blocking properties. Substances to be used as a transparent protective layer include, for example, a cellulose acetate resin or a film thereof such as triacetyl cellulose and diacetyl cellulose, an acryl resin or a film thereof, a polyvinyl chloride resin or a film thereof, a polyester resin or a film thereof, a polyarylate resin or a film thereof, a cyclic polyolefin resin where cyclic olefin such as norbornene is the monomer or a film thereof, polyethylene, polypropylene, polyolefin having a cyclo or norbornene skeletal structure or a copolymer thereof, a resin or a polymer where the backbone chain or a side chain is imide and/or amide or a film thereof, and the like. Polyvinyl alcohol can function as an alignment film for liquid crystal, so may be applied with rubbing treatment or treated with a photo alignment film in order to provide a resin having liquid crystallinity or a film thereof. The thickness of the protective film is, for example, approximately 0.5 μm to 200 μm. At least one layer of the same kind or different kinds of resins or films among them is provided on one or both of the surfaces to prepare a polarizing plate.

After laminating on one of the surfaces of the resulting polarizing plate, i.e., on a display device, an adhesion layer such as pressure-sensitive adhesive can be provided on the surface of the protective layer or film to be the non-exposed surface. Providing an adhesion layer enable laminating a polarizing plate on display devices such as liquid crystals and organic electro-luminescence.

This polarizing plate may have various known kinds of functional layers such as an antireflection layer, an antiglaring layer, a hard coat layer, a liquid crystal coating layer to improve visible angle and/or contrast on one of the surfaces, i.e., the exposed surface of the protective layer or film. The layers having functionalities are preferably applied by a coating method, otherwise a film having the functionalities may be laminated through an adhesive or a pressure-sensitive adhesive. Alternatively, the various kinds of functional layers can be a known retardation plate being a layer or film to control the retardation.

In providing a transparent protective layer on the polarizing film, if the protective layer is a film, it is necessary to perform film-laminating. In such a case, an adhesive is required. As the adhesive, a polyvinyl alcohol-based adhesive can be used. The polyvinyl alcohol-based adhesive includes, for example, GOHSENOL NH-26 (manufactured by Nippon Synthetic Chemical Industry Co.,) or EXCEVAL RS-2117 (manufactured by KURARAY CO., LTD.), but not limited thereto. A cross-linking agent and/or waterproofing agent may be added to the adhesive. Further, the adhesive may contain acidic substance at a concentration of 0.0001 to 20 wt %, preferably 0.02 to 5 wt %. A polyvinyl alcohol-based adhesive in which maleic anhydride-isobutylene copolymer only/and a cross-linking agent is mixed may be used. The maleic anhydride-isobutylene copolymer includes, for example, ISOBAM #18 (manufactured by KURARAY CO., LTD.), ISOBAM #04 (manufactured by KURARAY CO., LTD.), ammonia modified ISOBAM #104 (manufactured by KURARAY CO., LTD.), ammonia modified ISOBAM #110 (manufactured by KURARAY CO., LTD.), imidized ISOBAM #304 (manufactured by KURARAY CO., LTD.), imidized ISOBAM #310 (manufactured by KURARAY CO., LTD.), and the like. As a cross-linking agent in this regard, a water soluble polyvalent epoxy compound can be used. The water soluble polyvalent epoxy compound includes, for example, Denacol EX-521 (Nagase ChemteX Corporation), TETRAT-C (MITSUI LIQUEFIED GAS CO., LTD) and the like. A known adhesive can be used because other adhesives such as a urethane-based, an acrylic-based and an epoxy-based are frequently used, and the adhesive is not limited. In addition, as additives to the adhesive, a zinc compound, a halogenide and the like can be contained all together at a concentration of approximately 0.1 to 10 wt %. The additives are also not limited. The transparent protective layer is laminated with an adhesive and then dried at an appropriate temperature or subjected to heat treatment to obtain a polarizing plate.

Thus obtained polarizing plate of the present invention exhibits less change of transmittance and polarizing degree after being left for a long period of time under an atmosphere of high temperature and high humidity and less decrease of transmittance under circumstances of a high temperature, for example, at 90° C. and has superior durability, so it can maintain stable performance for a long period of time. The polarizing plate of the present invention is used for a liquid crystal display, an electroluminescence display device, a CRT and the like to obtain an image display device of the present invention. Especially in the case of a liquid crystal display, the polarizing plate of the present invention is laminated on the both sides of a liquid crystal cell composing a liquid crystal display, if necessary, together with a retardation film, with a pressure-sensitive adhesive to obtain a liquid crystal display of the present invention. Thus obtained image display device, particularly a liquid crystal display, where decrease of visibility of display image associated with deterioration of a polarizing plate is controlled lower, can display images with stability for a long period of time.

Hereinafter, the present invention will be explained more specifically by examples, but the present invention is not limited thereto. In this connection, evaluations on transmittance and polarizing degree were conducted as follows.

Transmittance in the case of putting together 2 polarizing plates obtained by laminating protective films on the both surfaces of a polarizing film so that those absorption axes are in the same direction is defined as a parallel transmittance Tp, and transmittance in the case of putting together 2 polarizing plates so that those absorption axes are orthogonal to each other is defined as orthogonal transmittance Tc.

Spectral transmittance τ λ was measured at every certain wavelength interval d λ (10 nm here) in the wavelength range of 380 to 780 nm, and transmittance T was calculated by the following formula (1). In the formula, Pλ represents a spectral distribution of standard light (light source C) and yλ represents a color matching function for a 2-degree field of view.

$$[ Formula 1 ]$$

$$T = \frac{{\int }_{380}^{780} P λ \cdot y λ \cdot τλ \cdot d λ}{{\int }_{380}^{780} P λ \cdot y λ \cdot d λ} \qquad ( 1 )$$

Spectral transmittance τλ was measured using a spectrophotometer (“U-4100” manufactured by Hitachi High-Technologies Corporation).

Polarizing degree Py is obtained from parallel-positioned transmittance Tp and orthogonal-positioned transmittance Tc by the formula (2).

Py={(Tp−Tc)/(Tp+Tc)}½×100 Formula (2)

The pH of aqueous solution was measured using a pH Controller “PP-01” manufactured by ASONE Corporation.

### EXAMPLE 1

A polyvinyl alcohol film (manufactured by KURARAY CO., LTD., trade name: VF-XS) having a saponification degree of no less than 99% and an average degree of polymerization of 2400 was immersed in hot water of 40° C. for 2 minutes to subject to swelling treatment, and then stretched by 1.30 times. The resulting film was immersed in an aqueous solution containing 28.6 g/l of boric acid (manufactured by Societa Chimica Larderello s.p.a.), 0.25 g/l of iodine (manufactured by JUNSEI CHEMICAL CO.,LTD.), 17.7 g/l of potassium iodide (manufactured by JUNSEI CHEMICAL CO.,LTD.) and 1.0 g/l of ammonium iodide (manufactured by JUNSEI CHEMICAL CO.,LTD.) at 30° C. for 2 minutes to carry out dyeing treatment with iodine and an iodide. The film obtained by dyeing treatment was subjected to treatment in an aqueous solution of 50° C. containing 30.0 g/l of boric acid for 5 minutes while uniaxially stretching by 5.0 times. The film obtained by boric acid treatment was subjected to treatment in an aqueous solution adjusted with 50 g/l of an potassium iodide and 0.02 g/l of aluminium sulfate 14-18 hydrate (manufactured by Wako Pure Chemical Industries, Ltd.) at 30° C. for 15 seconds, while maintaining the state of tension of the film. At that time, the pH of the aqueous solution was 4.8. The film obtained by the potassium iodide and acid treatment was subjected to drying treatment at 70° C. for 9 minutes. The film obtained by the drying treatment was laminated on a triacetyl cellulose film subjected to alkali treatment (manufactured by Fuji Photo Film Co., Ltd., trade name: TD-80U) using a polyvinyl alcohol-based adhesive to obtain a polarizing plate.

The resulting polarizing plate was cut out 40 mm×40 mm and laminated with a glass plate having a thickness of 1 mm through a pressure-sensitive adhesive (manufactured by NIPPON KAYAKU CO., LTD., trade name: PTR-3000) to prepare a measurement sample. Dry heat test and wet heat test were applied to the prepared sample.

Wet heat test was carried out in an atmosphere of a temperature of 65° C. and a relative humidity of 93%, and transmittances and polarizing degrees before and after the film was left for 18 days (432 hours) were measured. The film subjected to treatment with a solution containing an acidic substance and the film not subjected to the treatment were compared, which was an index to observe the superiority difference in increase of transmittance (decoloring) and decrease of polarizing degree.

The dry heat test was carried out in an atmosphere of 90° C., and transmittances before and after the film was left for 18 days (432 hours) were measured. The change of transmittance has advantageously an absolute value of no more than 1.0%, and being no more than 1.0% was determined to be the index. The change of transmittance by no less than 1.0% is not preferable because of causing such an influence that color reproducibility of a display device cannot be obtained. When the results in the dry heat test were judged by the absolute value of transmittance, change by no more than 1.0% is [good] and change by no less than 1.0% is [failure].

### EXAMPLE 2

In the same manner as in Example 1 except that the additive amount of aluminium sulfate 14-18 hydrate was 0.2 g/l and the pH was 3.4, a sample was prepared and its durabilitis in dry heat test and wet heat test were compared. The pH obtained by dissolving the polarizing film after drying treatment was 5.3.

### EXAMPLE 3

In the same manner as in Example 1 except that citric acid (absolute) (manufactured by JUNSEI CHEMICAL CO.,LTD.) was used instead of aluminium sulfate 14-18 hydrate, the additive amount was 0.05 g/l and the pH was 4.8, a sample was prepared and its durabilities in dry heat test and wet heat test were compared.

### EXAMPLE 4

In the same manner as in Example 3 except that the additive amount of citric acid was 0.07 g/l and the pH was 4.3, a sample was prepared and its durabilities in dry heat test and wet heat test were compared.

### EXAMPLE 5

In the same manner as in Example 3 except that the additive amount of citric acid was 0.1 g/l and the pH was 3.8, a sample was prepared and its durabilities in dry heat test and wet heat test were compared.

### EXAMPLE 6

In the same manner as in Example 3 except that the additive amount of citric acid was 0.3 g/l and the pH was 2.5, a sample was prepared and its durabilities in dry heat test and wet heat test were compared. The pH obtained by dissolving the polarizing film after drying treatment was 5.4.

### EXAMPLE 7

In the same manner as in Example 3 except that the additive amount of citric acid was 0.5 g/l and the pH was 2.3, a sample was prepared and its durabilities in dry heat test and wet heat test were compared. The pH obtained by dissolving the polarizing film after drying treatment was 5.3.

### EXAMPLE 8

In the same manner as in Example 1 except that acetic acid (manufactured by JUNSEI CHEMICAL CO.,LTD.) was used instead of aluminium sulfate 14-18 hydrate, the additive amount was 0.04 g/l and the pH of the solution was 5.1, a sample was prepared and its durabilities in dry heat test and wet heat test were compared.

### EXAMPLE 9

In the same manner as in Example 8 except that the additive amount of acetic acid was 0.07 g/l and the pH was 4.0, a sample was prepared and its durabilities in dry heat test and wet heat test were compared.

### EXAMPLE 10

In the same manner as in Example 8 except that the additive amount of acetic acid was 0.11 g/l and the pH was 3.8, a sample was prepared and its durabilities in dry heat test and wet heat test were compared.

### EXAMPLE 11

In the same manner as in Example 8 except that the additive amount of acetic acid was 0.6 g/l and the pH was 3.4, a sample was prepared and its durabilities in dry heat test and wet heat test were compared. The pH obtained by dissolving the polarizing film after drying treatment was 5.7.

### EXAMPLE 12

In the same manner as in Example 8 except that the additive amount of acetic acid was 3.0 g/l and the pH was 2.6, a sample was prepared and its durabilities in dry heat test and wet heat test were compared. The pH obtained by dissolving the polarizing film after drying treatment was 5.4.

### EXAMPLE 13

In the same manner as in Example 8 except that the additive amount of acetic acid was 5.0 g/l and the pH was 2.4, a sample was prepared and its durabilities in dry heat test and wet heat test were compared. The pH obtained by dissolving the polarizing film after drying treatment was 5.1.

### COMPARATIVE EXAMPLE 1

In the same manner as in Example 1 except that aluminium sulfate 14-18 hydrate was not added, a sample was prepared and its durabilities in dry heat test and wet heat test were compared. The pH obtained by dissolving the polarizing film after drying treatment was 6.0.

The measurement results of the changes of transmittance and polarizing degree in Examples 1 to 13 and Comparative Example 1 are shown in Tables 1 and Table 2.

Table 1: Change of transmittance and polarizing degree before and after wet heat durability test.

TABLE 1

| | Before Dry | | 65° C. × 93% | | | | | |
|---|---|---|---|---|---|---|---|---|
| | Heat Test | | RH × 432 Hours Later | | | | | |
| | TM (%) | P.D. (%) | TM (%) | P.D. (%) | T.C. | C.P.D. | pH of T.S. | pH of S.D.P.F. |
| Example 1 | 43.72 | 99.95 | 44.71 | 98.50 | 0.99 | −1.45 | 4.8 | |
| Example 2 | 43.72 | 99.88 | 44.70 | 98.75 | 0.98 | −1.13 | 3.4 | 5.3 |
| Example 3 | 43.87 | 99.95 | 45.10 | 97.82 | 1.23 | −2.13 | 4.8 | |
| Example 4 | 43.72 | 99.93 | 44.93 | 98.32 | 1.21 | −1.61 | 4.2 | |
| Example 5 | 43.88 | 99.96 | 44.75 | 98.87 | 0.87 | −1.09 | 3.8 | |
| Example 6 | 43.75 | 99.95 | 44.31 | 99.38 | 0.56 | −0.57 | 2.6 | 5.4 |
| Example 7 | 43.84 | 99.95 | 44.22 | 99.46 | 0.38 | −0.49 | 2.4 | 5.3 |
| Example 8 | 43.94 | 99.91 | 45.24 | 95.5 | 1.30 | −3.41 | 5.1 | |
| Example 9 | 43.85 | 99.92 | 44.81 | 97.78 | 0.96 | −2.16 | 4.1 | |
| Example 10 | 43.93 | 99.94 | 44.67 | 98.5 | 0.74 | −1.44 | 3.8 | |
| Example 11 | 43.83 | 99.91 | 44.32 | 98.82 | 0.49 | −1.09 | 3.4 | 5.7 |
| Example 12 | 43.72 | 99.92 | 43.98 | 99.31 | 0.26 | −0.61 | 2.7 | 5.4 |
| Example 13 | 43.87 | 99.89 | 44.01 | 99.45 | 0.14 | −0.44 | 2.4 | 5.1 |
| C. Ex. 1 | 43.76 | 99.93 | 45.98 | 94.84 | 2.22 | −5.09 | 7.0 | 8.0 |

TM: Transmittance
P.D.: Polarizing Degree
T.C.: Transmittance Change
C.P.D.: Change of Polarizing Degree
pH of T.S.: pH of Treatment Solution
pH of S.D.P.F.: pH of Solution Dissolving Polarizing Film
C. Ex.: Comparative Example

Table 2: Change of transmittance and polarizing degree before and after dry heat durability test.

TABLE 2

| | [symbol] | [symbol] | [symbol] | | [symbol] | |
|---|---|---|---|---|---|---|
| | Transmittance | 90° C. × Transmittance | Change of | [symbol] | pH of Solution | [symbol] |
| | before Dry Heat | (%) | Polarizing | pH of Treatment | Dissolving | Result of Dry |
| | Test | 432 Hours Later | Degree | Solution | Polarizing Film | Heat Test |
| Example 1 | 43.80 | 44.12 | 0.32 | 4.8 | | Good |
| Example 2 | 43.80 | 44.08 | 0.28 | 3.4 | 5.3 | Good |
| Example 3 | 43.73 | 44.09 | 0.36 | 4.8 | | Good |
| Example 4 | 43.74 | 44.14 | 0.4 | 4.2 | | Good |
| Example 5 | 43.63 | 44.00 | 0.37 | 3.8 | | Good |
| Example 6 | 43.71 | 43.90 | 0.19 | 2.6 | 5.4 | Good |
| Example 7 | 43.82 | 43.60 | −0.22 | 2.4 | 5.3 | Good |
| Example 8 | 43.77 | 44.23 | 0.46 | 5.1 | | Good |
| Example 9 | 43.72 | 43.91 | 0.19 | 4.1 | | Good |
| Example 10 | 43.78 | 44.14 | 0.36 | 3.8 | | Good |
| Example 11 | 43.74 | 44.05 | 0.31 | 3.4 | 5.7 | Good |
| Example 12 | 43.72 | 43.92 | 0.20 | 2.7 | 5.4 | Good |
| Example 13 | 43.68 | 43.60 | −0.08 | 2.4 | 5.1 | Good |
| C. Ex. 1 | 43.89 | 44.18 | 0.29 | 7.0 | 6.0 | Good |

C. Ex.: Comparative Example [symbol]
indicates data missing or illegible when filed

As can be found from the above Examples and Comparative Example, as for the film applied with stretching treatment after a cross-linking agent was contained in the polyvinyl alcohol resin film containing iodine and an iodide, the polarizing film obtained by treatment with a solution containing 0.0001 to 5.0 wt % of acidic substance except for boric acid and having a pH of 2.4≦pH<6.0 in the present invention is a polarizing film or polarizing plate having no decoloring and less decrease in polarizing degree under wet heat circumstances of, for example, a temperature of 65° C. and a relative humidity of 93%. A polarizing plate providing high transmittance, high contrast and high wet heat durability in the polarizing film for liquid crystal displays can be obtained. Further, it is found that the polarizing film obtained according to the present invention has such dry heat durability that a transmittance change is no more than 1.0% in dry heat test of, for example, 90° C. Judging from the above results, it is found that the pH of treatment solution can provide a polarizing plate having improved wet heat durability and less transmittance change in dry heat durability. On the other hand, judging from the pH of treatment solution and the pH obtained by dissolving the polarizing film, as the treatment is carried out with a treatment solution having a higher concentration of acidic substance, the pH obtained by dissolving the polarizing film is lower. Accordingly, it is found that the concentration of acidic substance and the concentration of polarizing film have a correlation with each other. As the concentration of acidic substance is lower, the pH obtained by dissolving the polarizing film shows a value closer to 6, and its wet heat durability gradually deteriorates although its transmittance dose not decrease in dry heat test of, for example, 90° C. It is found that as the pH obtained by dissolving the polarizing film is closer to 5, a higher value is shown in wet heat durability, and that when the pH is not more than 5, significant decrease in transmittance is observed in dry heat test of 90° C. Judging from the above results, it is found that the polarizing plate obtained by treatment of a polyvinyl alcohol resin film containing iodine with a solution containing 0.0001 to 5.0 wt % of acidic substance except for boric acid and having a pH of 2.4≦pH<6.0 is a polarizing plate having improved wet heat durability and less change of transmittance in dry heat durability.

### EXAMPLE A-2

In the same manner as in Example 1 except that the additive amount of aluminium sulfate 14-18 hydrate was 4.5 g/l and the pH was 2.73, a sample was prepared and its durability in wet heat test was compared.

### EXAMPLE A-3

In the same manner as in Example 1 except that sulfuric acid (manufactured by JUNSEI CHEMICAL CO., LTD.) was used instead of aluminium sulfate 14-18 hydrate, the additive amount was 0.2 g/l and the pH was 1.88, a sample was prepared and its durability in wet heat test was compared.

### EXAMPLE A-4

In the same manner as in Example 1 except that sulfuric acid (manufactured by JUNSEI CHEMICAL CO., LTD.) was used instead of aluminium sulfate 14-18 hydrate, the additive amount was 0.03 g/l and the pH was 3.4, a sample was prepared and its durability in wet heat test was compared.

### EXAMPLE A-5

In the same manner as in Example 1 except that aluminium nitrate (manufactured by Wako Pure Chemical Industries, Ltd.) was used instead of aluminium sulfate 14-18 hydrate, the additive amount was 5 g/l and the pH was 2.91, a sample was prepared and its durability in wet heat test was compared.

### EXAMPLE A-6

In the same manner as in Example 1 except that aluminium chloride 6-hydrate (manufactured by Wako Pure Chemical Industries, Ltd.) was used instead of aluminium sulfate 14-18 hydrate, the additive amount was 5 g/l and the pH was 2.83, a sample was prepared and its durability in wet heat test was compared.

### EXAMPLE A-7

A polyvinyl alcohol film (manufactured by KURARAY CO., LTD., trade name: VF-XS) having an average degree of polymerization of 2400 was immersed in hot water of 40° C. for 2 minutes and applied with swelling treatment with a stretching ratio of 1.30 times. The film subjected to swelling treatment was immersed in an aqueous solution containing 0.25 g/l of iodine (manufactured by JUNSEI CHEMICAL CO., LTD.) and 17.7 g/l of potassium iodide (manufactured by JUNSEI CHEMICAL CO., LTD.) at 30° C. for 2 minutes to carry out iodine and iodide treatment. The dyed film was applied with treatment at a concentration of 28 g/l of boric acid (manufactured by Societa Chimica Larderello s.p.a.) at a treatment temperature of 30° C. for 5 minutes. The film applied with boric acid treatment was subjected to treatment in an aqueous solution of 50° C. containing 30.0 g/l of boric acid for 5 minutes while stretching the film by 5.0 times. The film obtained by boric acid treatment was subjected to treatment with an aqueous solution adjusted with 50 g/l of potassium iodide and 3.5 g/l of citric acid (manufactured by JUNSEI CHEMICAL CO., LTD.) with the temperature kept at 30° C., for 15 seconds, while keeping the state of tension of the film. The pH of the aqueous solution was 1.51. The film obtained by potassium iodide treatment with citric acid contained was subjected to dry treatment at 70° C. for 9 minutes. The film obtained by drying was laminated on a triacetyl cellulose film subjected to alkali treatment (manufactured by Fuji Photo Film Co., Ltd., trade name: TD-80U) using a polyvinyl alcohol-based adhesive to obtain a polarizing plate.

The resulting polarizing plate was cut out 40 mm×40 mm and laminated with a glass plate having a thickness of 1 mm through a pressure-sensitive adhesive (manufactured by NIPPON KAYAKU CO., LTD., trade name: PTR-3000) to prepare a measurement sample.

The prepared sample was applied with wet heat test. The wet heat test was conducted in an atmosphere of a temperature of 65° C. and a relative humidity of 93%, and unit transmission degree and polarizing degree were measured before and after it was left for 18 days (432 hours).

### EXAMPLE A-8

In the same manner as in Example A-7 except that the additive amount of citric acid was 0.05 g/l and the pH was 4.8, a sample was prepared and its durability in wet heat test was compared.

### EXAMPLE A-9

In the same manner as in Example A-7 except that acetic acid was used instead of citric acid, the additive amount of acetic acid was 0.04 g/l and the pH was 5.1, a sample was prepared and its durability in wet heat test was compared.

### EXAMPLE A-10

In the same manner as in Example A-7 except that acetic acid was used instead of citric acid, the additive amount of acetic acid was 3.0 g/l and the pH was 2.58, a sample was prepared and its durability in wet heat test was compared.

### COMPARATIVE EXAMPLE 1

In the same manner as in Example 1 except that aluminium sulfate 14-18 hydrate was not added, a sample was prepared and its durability in wet heat test was compared.

### COMPARATIVE EXAMPLE A-2

In the same manner as in Example A-7 except that citric acid was not added, a sample was prepared and its durability in wet heat test was compared.

### COMPARATIVE EXAMPLE A-3

In the same manner as in Example A-4 except that the film obtained by dye treatment was subjected to stretching treatment by 5.0 times for 5 minutes while keeping the aqueous solution of 50° C. containing 30.0 g/l of boric acid at pH of 3.4, and the film obtained by boric acid treatment was subjected to treatment in an aqueous solution adjusted with 50 g/l of potassium iodide, at 30° C. for 15 seconds while maintaining the state of tension of the film, a sample was prepared and its durability in wet heat test was compared.

The measurement results of transmittances and change of polarizing degrees in Examples 1, A-2 to A-10 and Comparative Examples 1, A-2 and A-3 are shown in Table 1.

TABLE A-1
[Table A-1]

| | Before Dry | | 5° C. × 93% | | | Change of |
|---|---|---|---|---|---|---|
| | Heat Test | | RH × 432 Hours Later | | Transmittance | Polarizing |
| | TM (%) | P.D. (%) | TM (%) | P.D. (%) | Change | Degree |
| Example 1 | 43.72 | 99.95 | 44.71 | 98.50 | 0.99 | −1.45 |
| Example A-2 | 43.92 | 99.88 | 44.51 | 99.18 | 0.59 | −0.70 |
| Example A-3 | 43.67 | 99.94 | 44.13 | 99.68 | 0.46 | −0.26 |
| Example A-4 | 43.78 | 99.93 | 44.32 | 99.54 | 0.54 | −0.39 |
| Example A-5 | 43.34 | 99.93 | 44.01 | 98.48 | 0.67 | −1.45 |
| Example A-6 | 43.45 | 99.95 | 43.88 | 98.58 | 0.43 | −1.37 |
| Example A-7 | 43.68 | 99.93 | 43.91 | 99.6 | 0.23 | −0.33 |
| Example A-8 | 43.7 | 99.96 | 44.91 | 98.38 | 1.21 | −1.58 |
| Example A-9 | 43.56 | 99.95 | 44.61 | 98.5 | 1.05 | −1.45 |
| Example A-10 | 43.5 | 99.95 | 43.81 | 99.41 | 0.31 | −0.54 |
| C. Ex. 1 | 43.76 | 99.93 | 45.98 | 94.84 | 2.22 | −5.09 |
| C. Ex. A-2 | 43.76 | 99.95 | 45.82 | 95.54 | 2.06 | −4.41 |
| C. Ex. A-3 | 43.92 | 99.91 | 44.91 | 97.22 | 0.99 | −2.69 |

TM: Transmittance
P.D.: Polarizing Degree
C. Ex.: Comparative Example

As can be found from the above Examples and Comparative Examples, as for the film applied with stretching treatment after a cross-linking agent was contained in a polyvinyl alcohol resin film containing iodine and an iodide of the present invention, the polarizing film obtained by treatment with a solution containing 0.0001 to 5.0 wt % of acidic substance except for boric acid and having a pH of 1.0≦pH<6.0 is a polarizing film or polarizing plate having no decoloring and less decrease in polarizing degree under wet heat circumstances of, for example, a temperature of 65° C. and a relative humidity of 93%. A polarizing plate having high transmittance, high contrast and high wet heat durability in a polarizing film for liquid crystal displays can be obtained. In addition, compared Example 4 and Comparative Example 3, it is found that by adjusting the pH of halogenide treatment bath at 1.0≦pH<6.0, the treatment was conducted more effectively.

1. A polarizing film obtained by treatment of a polyvinyl alcohol resin film containing iodine, an iodide, a cross-linking agent and/or a waterproofing agent with a solution containing 0.0001 to 5.0 wt % of an inorganic acid or a salt thereof and/or an organic acid except for boric acid (hereinafter, referred to as solution for acid treatment) after stretching.

2. The polarizing film according to claim 1, wherein the pH of the solution for acid treatment is 2≦pH≦5.

3. The polarizing film according to claim 1, obtained by treatment of a polyvinyl alcohol resin film containing iodine, an iodide, a cross-linking agent and/or a waterproofing agent with a solution for acid treatment having a pH of 2.4≦pH<6.0 after stretching treatment.

4. The polarizing film according to claim 1, characterized by containing a halogenide in the solution containing inorganic acid or a salt thereof and/or organic acid except for boric acid.

5. The polarizing film according to claim 1, wherein the inorganic acid or a salt thereof except for boric acid is any one or no less than two of aluminium sulfate, aluminium chloride, aluminium nitrate or sulfuric acid.

6. The polarizing film according to claims 1 and 2, wherein the inorganic acid or a salt thereof except for boric acid is aluminium sulfate.

7. The polarizing film according to any one of claims 1 to 6, wherein the organic acid is no less than one kind of carboxylic acids and/or α-hydroxy acids and which is obtained by treatment with a solution containing said organic acid.

8. The polarizing film according to claim 7, wherein the organic acid is any one or more of citric acid, oxalic acid, malic acid, tartaric acid or acetic acid and which is obtained by treatment with a solution containing said organic acid.

9. The polarizing film according to any one of claims 1 to 8, wherein the above polyvinyl alcohol resin film after stretching is one stretched at a stretching ratio of 3 to 8 times compared to before stretching.

10. The polarizing film according to claim 1 or 9, characterized by that the cross-linking agent and/or a waterproofing agent to be used during stretching treatment is boric acid.

11. A polarizing plate provided with a protection layer on either or both of the surfaces of the polarizing film according to any of claims 1 to 8.

12. A liquid crystal display device characterized by having the polarizing plate according to claim 11.

13. A method for producing a polarizing film characterized by treatment of a polyvinyl alcohol resin film containing iodine, an iodide, a cross-linking agent and/or a waterproofing agent with a solution for acid treatment having 2.4≦pH<6.0 after stretching treatment.

14. A method for producing a polarizing plate characterized by providing a protective layer on either or both of the surfaces of the polarizing film obtained by treatment of a polyvinyl alcohol resin film containing iodine, an iodide, a cross-linking agent and/or a waterproofing agent with a solution for acid treatment having 2.4≦pH<6.0 after stretching treatment.

15. A method for producing a polarizing film characterized by treatment a polyvinyl alcohol resin film containing iodine, an iodide, and a cross-linking agent with a solution for acid treatment having 2.2≦pH≦5 after stretching treatment.

16. A method for producing a polarizing film characterized by treatment a polyvinyl alcohol resin film containing iodine, an iodide, and a cross-linking agent and/or a waterproofing agent with a solution containing 0.0001 to 5.0 wt % of inorganic acid except for boric acid or a salt thereof and/or organic acid (hereinafter, referred to as solution for acid treatment) after stretching.

17. A method for producing the polarizing film according to claim 15, wherein the solution for acid treatment is an aqueous solution containing at least one kind of acidic substance selected from the group consisting of sulfuric acid, hydrochloric acid, nitric acid, aluminium sulfate, aluminium chloride, aluminium nitrate, formic acid, citric acid, chloroacetic acid, acetic acid, oxalic acid, malic acid and tartaric acid.

18. A method for producing the polarizing film according to claim 16 or 17, wherein the pH of the solution for acid treatment is 2 to 5.
